(19) United States
(12) Patent Application Publication
(10) Pub. No.: US 2015/0300888 A1
(43) Pub. Date: Oct. 22, 2015

(54) TEMPERATURE PREDICTION SYSTEM AND METHOD THEREOF

(71) Applicant: NATIONAL TAIWAN UNIVERSITY, Taipei (TW)

(72) Inventors: Kun-Chih CHEN, Taipei (TW); An-Yeu WU, Taipei (TW); Huai-Ting LI, Taipei (TW)

(73) Assignee: NATIONAL TAIWAN UNIVERSITY, Taipei (TW)

(21) Appl. No.: 14/257,992

(22) Filed: Apr. 21, 2014

(51) Int. Cl. G01K 3/10; G01K 7/22

(52) U.S. Cl. CPC G01K 3/10; G01K 7/22

(57) ABSTRACT

A temperature prediction system and method thereof use sensors to sense the temperature at a plurality of times, thereby calculating an actual temperature difference between the current time and the previous time. According to the result of actual temperature difference, an adaptive filter is used to predict a predicted temperature difference at a future time and to add the temperature of the current time and the predicted temperature difference to render a predicted temperature. By calculating the difference between the temperature at the next time and the predicted temperature at the next time, the filter parameter of the adaptive filter is adjusted. This mechanism helps improving the accuracy in temperature predictions.

### BACKGROUND OF RELATED ART

1. Technical Field

The invention relates to a temperature prediction system and the method thereof. In particular, the invention relates to a temperature prediction system that utilizes an adaptive filter to increase the accuracy in temperature predictions and the method thereof.

2. Related Art

In recent years, with the advent of semiconductor technology, the density of electronic elements on a chip increases significantly. There are even 3D integrated chips (IC) with a vertical structure, which results in higher power consumption and problems with heat dissipation. Therefore, it is an imperative task for manufacturers to invent better temperature management.

In practical, the conventional method of temperature management sets a temperature threshold. When the temperature exceeds the temperature threshold, the system immediately decreases frequency or voltage to control the temperature rise. However, this method can result in serious system performance degradation during the period of temperature management.

In view of this related arts, some vendors provide a proactive temperature management mechanism. Through temperature predictions, some techniques with less impact on the system efficiency are employed to control the temperature. However, such methods rely on the precision of temperature predictions. There are two solutions to increase the precision of the temperature prediction. The first one is a table-based prediction scheme, and the second one is a computing-based prediction scheme. For the first scheme, the prediction precision is directly related to the table memory area. Therefore, it is not suitable for an area-limited single system chip. The second scheme relies on more accurate design parameters, such as thermal resistance and thermal capacitance, in order to obtain precise results of temperature prediction. The mechanism of temperature prediction can help to build aforementioned proactive temperature management. Nevertheless, due to the constraints of physical properties, the values of thermal resistance and thermal capacitance swing with respect to different temperature, which in turn causes error in the predictions. Therefore, the above-mentioned methods cannot effectively solve the problem with imprecise temperature predictions.

In summary, the skilled person in the art always has the problem of imprecise temperature predictions. It is imperative to provide a better solution.

### SUMMARY

The invention discloses a temperature prediction system and the method thereof.

The disclosed system includes: a sensing module, a predicting module, a computing module, and an adjusting module. The sensing module detects a temperature at a plurality of times. It continuously calculates a temperature difference between the temperature at current time and that at the previous time, which can be used to obtain the actual temperature difference. According to the actual temperature difference, the predicting module uses an adaptive filter and the filter parameter thereof to calculate a predicted temperature difference at a future time. The predicted temperature difference at a future time is added to the temperature at the current time to output a corresponding predicted temperature. The computing module computes a temperature difference between the temperature at the next time and the predicted temperature at the next time as the prediction error. The adjusting module adjusts the filter parameter according to the prediction error.

The disclosed method includes the steps of: temperature sensing at a plurality of times and continuously calculating a temperature difference between the current time and the previous time as an actual temperature difference; using an adaptive filter and the filter parameter thereof to calculate a predicted temperature difference at a future time based on the actual temperature difference and adding the temperature at the current time to the predicted temperature difference of the future time to output a corresponding predicted temperature; calculating a temperature difference between the temperature at the next time and the predicted temperature for the next time as a prediction error; and adjusting the filter parameter according to the prediction error.

The disclosed system and method as described above differ from the prior art in that the invention employs sensors to sense a temperature at a plurality of times and calculates an actual temperature difference between the current time and the previous time. Based on the actual temperature difference, an adaptive filter is used to calculate a predicted temperature difference at a future time. The temperature at the current time and the predicted temperature difference are added to produce a predicted temperature. By calculating the difference between the temperature at the next time and the predicted temperature for the next time, the filter parameter of the adaptive filter is adjusted.

Using the above-mentioned means, the invention achieves the goal of increasing the precision in temperature predictions.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed temperature direction system;

FIG. 2 is a flowchart of the disclosed temperature prediction method;

FIG. 3 is a schematic view of using the invention to calculate a predicted temperature;

FIG. 4 is a schematic view of the adaptive filter used in the invention; and

FIGS. 5A and 5B are schematic view showing the changes in the filter parameter according to the invention.

### DETAILED DESCRIPTION

The present invention will be apparent from the following detailed description, which proceeds with reference to the accompanying drawings, wherein the same references relate to the same elements.

Before describing in detail the disclosed temperature prediction system and the method thereof, we first define terms used in this specification. The filter parameter is called a “W” parameter and “W=e^{-bΔt}^{ₛ}”, where b is equal to 1/RC, R is the thermal resistance, C is the thermal capacitance, “Δtₛ” is the time increment (or thermal sensing period). For example, suppose the current time is “t”. The previous time is then “t−Δtₛ”, the next time (first future time) is “t+Δtₛ”, the second future time is “t+2Δtₛ”, the third future time is “t+3Δtₛ”, . . . , and the k-th future time is “t+Δtₛ”. The temperature predictions at various times will be explained with reference to accompanying plots later.

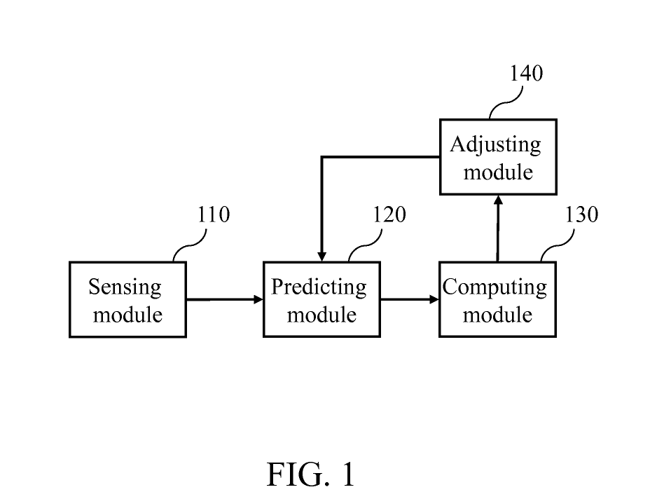

Please refer to FIG. 1 for a system block diagram of the disclosed temperature direction system. Used in a chip with a temperature management mechanism, the system includes: a sensing module 110, a predicting module 120, a computing module 130, and an adjusting module 140. The sensing module 110 uses sensors to sense a temperature at a plurality of times and continuously calculates an actual temperature difference between the actual temperature “T*(t)” at the current time “t” and the actual temperature “T*(t−Δtₛ)” at the previous time. In practice, the sensing module 110 employs a thermistor that has a resistance that varies with temperature, thereby measuring the temperature by observing an electric current or voltage thereof.

With the actual temperature difference obtained by the sensing module 110, the predicting module 120 uses an adaptive filter and its filter parameter “W” to calculate a predicted temperature difference for the future time. The temperature at the current time is added with the predicted temperature difference at the future time to render a corresponding predicted temperature for the temperature management mechanism of the chip to use. The predicted temperature can be computed using linear extrapolation. In practice, the adaptive filter and the filter parameter can be used to calculate predicted temperature differences at a plurality of future times at the same time, thereby obtaining the corresponding predicted temperatures. For example, the predicted temperature at the first future time is represented by “T(t+Δtₛ)”, that at the second future time by “T(t+2Δtₛ)”, . . . , and that at the k-th future time by “T(t+kΔtₛ)”. Take the predicted temperature “T(t+Δtₛ)” at the first future time as an example. “T(t+Δtₛ)=T*(t)+ΔT*(t)·e^{-bΔt}^{ₛ}”, where “T*(t)” is the actual temperature of the current time “t”, “ΔT*(t)” is the temperature difference, and “e^{-bΔt}^{ₛ}” is the filter parameter. Because the filter parameter “e^{-bΔt}^{ₛ}” has been defined before, it is not repeated herein. For the adjustment of filter parameter, the adaptive filter can use either the least mean square (LMS) algorithm or the recursive least square (RLS) algorithm for its computations. These two algorithms differ only in the way of adjusting the filter parameter. In the LMS algorithm, the change in each filter parameter adjustment is the same in each time. In the RLS algorithm, an optimal change is obtained in each time. Therefore, the RLS algorithm has a faster converging speed than the LMS algorithm. Nevertheless, the RLS algorithm involves matrix operations and is therefore more complicated. In an environment that supports complicated operations, one can select the RLS algorithm to increase the converging speed of the parameter. It should be emphasized that other algorithms can be employed for the adaptive filter. The invention is not limited to the LMS or RLS algorithm. Moreover, since such algorithms are well known in the prior art, they are not further described herein.

The computing module 130 calculates a difference between the temperature of the next time and the predicted temperature for the next time as a prediction error. In other words, the computing module 130 calculates the difference between the actual temperature and the predicted temperature for the next time as the prediction error.

The adjusting module 140 adjusts the filter parameter of the adaptive filter according to the prediction error. That is, the adjusting module 140 adjusts the involved filter parameter for calculating predicted temperature to avoid the problem of decreased prediction precision because of the filter parameter sensing with respect to different temperature. Later on, we will use figures to describe the adjusted changes in the filter parameter of the adaptive filter.

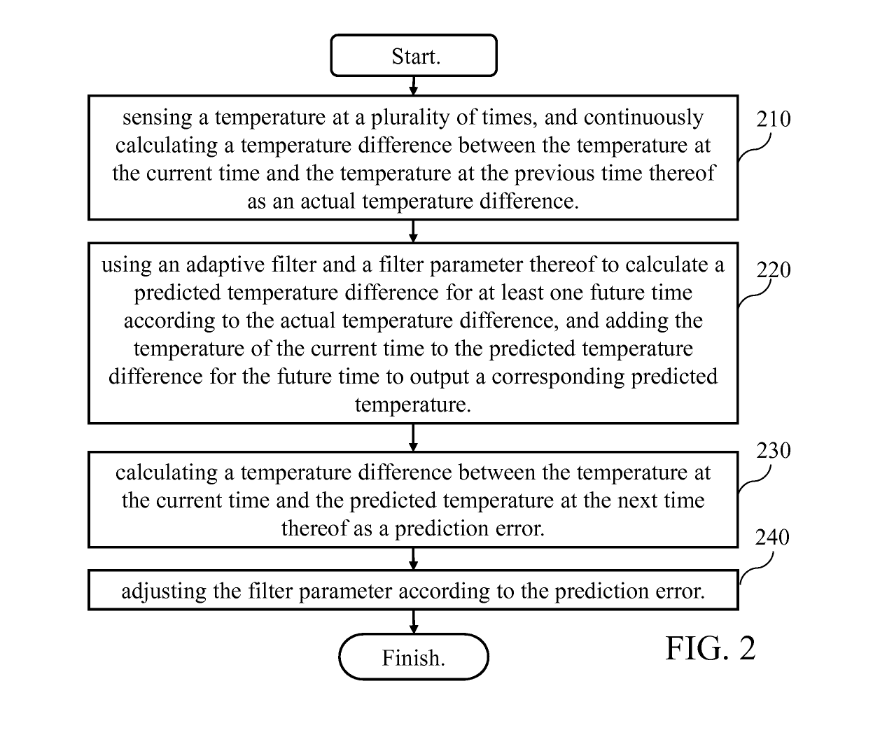

Please refer to FIG. 2 for a flowchart of the disclosed temperature prediction method. Used in a chip with a temperature management mechanism, the disclosed method includes the steps of: detecting a temperature at a plurality of times, and continuously calculating a difference between the temperature at the current time and the temperature at the previous time as an actual temperature difference (step 210); based on the actual temperature difference, using an adaptive filter and the filter parameter thereof to calculate a predicted temperature difference for a future time, and adding the temperature at the current time to the predicted temperature difference for the future time to render a corresponding predicted temperature (step 220); calculating a difference between the temperature at the next time and the predicted temperature for the next time as a prediction error (step 230); and using the prediction error to adjust the filter parameter (step 240). Through the above-mentioned steps, the sensors sense the temperature at many times and calculate the actual temperature difference between the current time and the previous time. Based upon the actual temperature difference, the adaptive filter is used to calculate the predicted temperature difference for a future time. The temperature at the current time is added to the predicted temperature difference to render the predicted temperature. The difference between the temperature at the current time and the predicted temperature for the next time is then used to adjust the filter parameter of the adaptive filter.

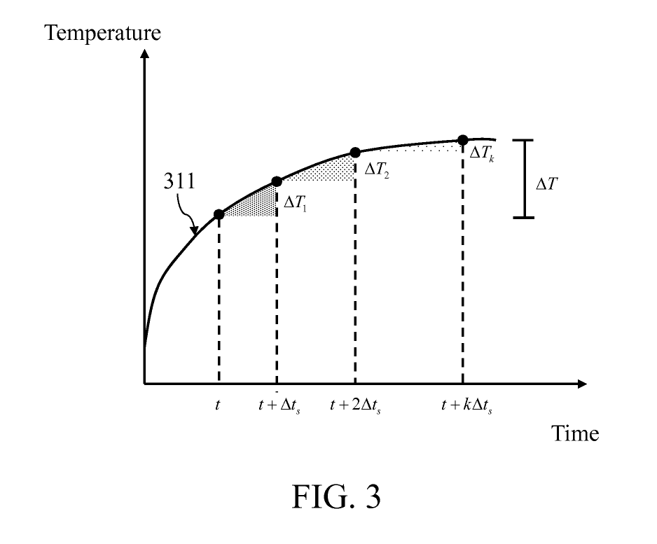

In the following paragraphs, an embodiment is used to explain the invention with reference to FIGS. 3 to 5B. Please first refer to FIG. 3, which is a schematic view of using the invention to calculate a predicted temperature. In the plot, the horizontal axis is time, and the vertical axis is temperature. The temperature curve 311 shows the temperature evolving in time. The horizontal axis labels each of the times. For example, the current time is “t”, the first future time is “t+Δtₛ” the second future time is “t+2Δtₛ”, . . . , and the k-th future time is “t+kΔtₛ”. Suppose one is to calculate the predicted temperature “T(t+kΔtₛ” for the k-th future time “t+kΔtₛ”. The predicting module 120 adds to the temperature “T(t)” at the current time “t” the sum of the predicted temperature differences of the future times “ΔT”, thereby obtaining a corresponding predicted temperature “T(t+lΔtₛ” That is, “T(t+kΔtₛ)=T*(t)+ΔT*(t)·e^{-bΔt}^{ₛ}+ΔT*(t)·e^{-b·2Δt}^{ₛ}+ . . . +ΔT*(t)·e^{-b·kΔt}^{ₛ}”. It should be explained that the above formula is obtained by first differentiating the general form of “Tₛₛ−(Tₛₛ−T₀)·e^{-bt}” the temperature of the current time “t”, “T(t)”, followed by linear extrapolation. Here “Tₛₛ” represents a steady-state temperature, “T₀” is the initial temperature, “b” is a temperature parameter (i.e., the above-mentioned “1/RC”). Therefore, “ΔT*(t)·e^{-bΔt}^{ₛ}” is the predicted temperature difference “ΔT₁” at the first future time “t+Δtₛ”, “ΔT*(t)·e^{-b·2Δt}^{ₛ}” is the predicted temperature difference “ΔT₂” at the second future time, “t+2Δtₛ” and “ΔT*(t)·e^{-b·kΔt}^{ₛ}” the predicted temperature difference “ΔTₖ” at the k-th future time “t+kΔtₛ”. The sum of these predicted temperature difference is “ΔT” The above-mentioned formula can also be written as

$$\\ {}_{“}^{}{T}{}_{}^{*} ( t ) + Δ {T}^{*} ( t ) {\sum }_{j = 1}^{k} {e}^{- b \cdot jΔ {t}_{s}} ” ,$$

where the temperature “T*(t)” of the current time “t” is measured by the sensing module 110.

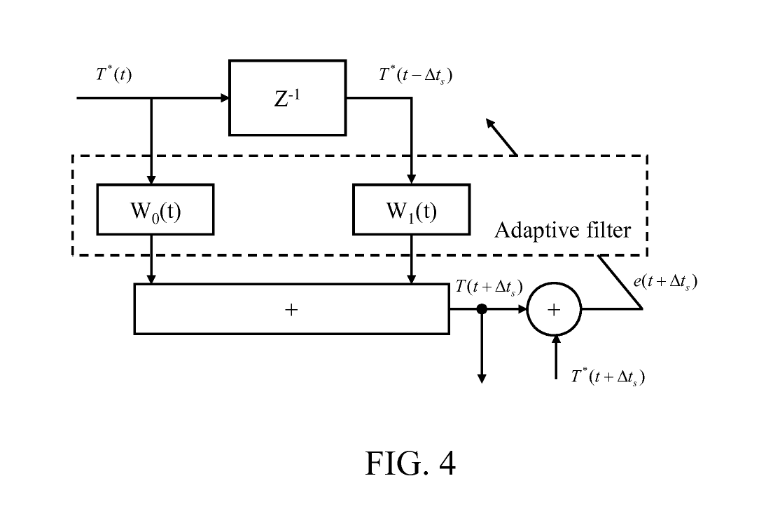

As shown in FIG. 4 which is a schematic view of the adaptive filter used in the invention. “W₀(t)” and “W₁ (t)” are parameters of accurate thermistor capacitance obtained by adaptive signal processing. In the following design example, the LMS algorithm is used in the adaptive filter. As mentioned before, the predicted temperature at the first future time is, “T(t+Δtₛ)”, which can be expressed as “T(t+Δtₛ)=T*(t)+ΔT*(t)·e^{-bΔt}^{ₛ}”. Because the actual temperature difference “ΔT*(t)” is equal to the difference between the actual temperature of the current time “t”, “T*(t)”, and the actual temperature of the previous time “t−Δtₛ”, “T*(t−Δtₛ)”, (i.e., “ΔT*(t)=T*(t)−T*(t−Δtₛ)”), the formula of predicted temperature at the first future time can be derived to “T(t+Δtₛ)=(1+e^{-bΔt}^{ₛ})·T*(t)−(e^{-bΔt}^{ₛ})·T*(t−Δtₛ)”. Furthermore, the filter parameter is equal to e^{-bΔt}^{ₛ}. Therefore, “T(T+Δtₛ)=W·T*(t)−(W−1)·T*(t−Δtₛ)”, where “W” can be taken as “W₀(t)” and “(W−1)” as “W₁(t)”. It is thus seen that “W₁(t)=W₀(t)−1”. Likewise, with “W₀(t+Δtₛ)”, one has “W₁(t+Δtₛ)=W₀(t+Δtₛ)−1”, where “W₀(t+Δtₛ)=W₀(t)+Δtₛ·e(t)·T*(t)”. “e(t+Δtₛ)” refers to the prediction error, the difference between the actual temperature “T*(t+Δtₛ)” of the next future time and the predicted temperature “T(t+Δtₛ)” for the next future time obtained by the computing module 130; that is, “e(t+Δtₛ)=T*(t+Δtₛ)−T(t+Δtₛ)”. The prediction error is then used to adjust the filter parameter of the adaptive filter.

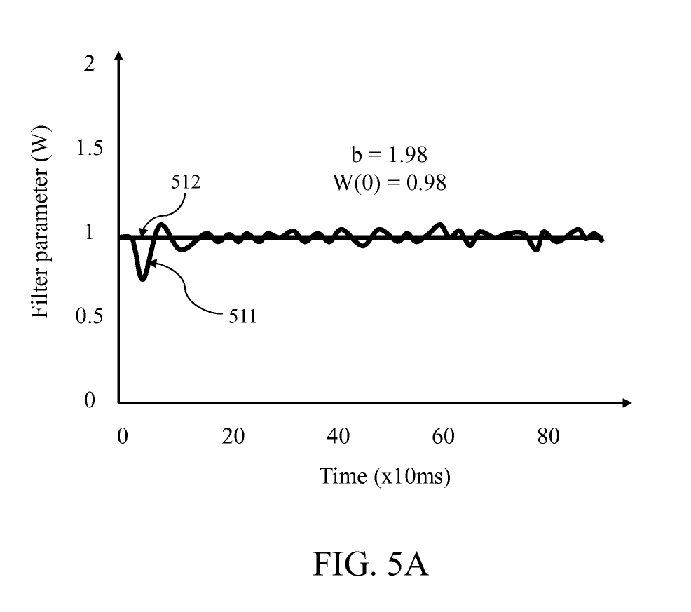

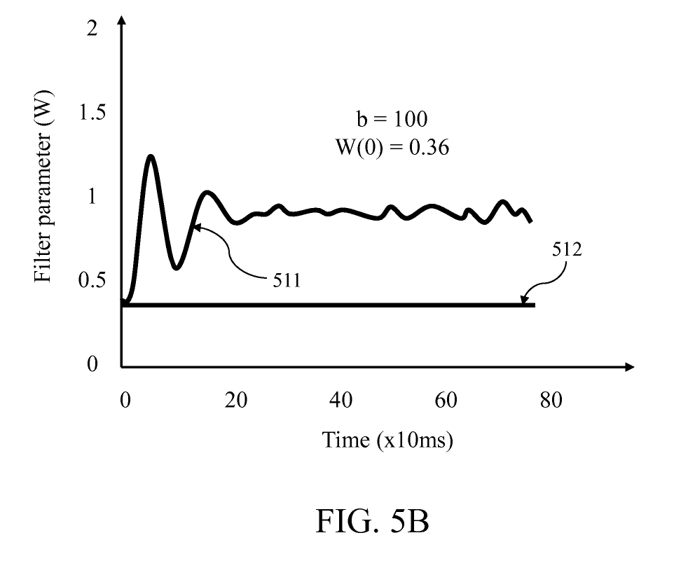

FIGS. 5A and 5B illustrate two examples to show the changes in the filter parameter according to the invention. As mentioned before, the adjusting module 140 uses the prediction error to adjust the filter parameter. As shown in FIG. 5A, initially b is equal to 1.98, which leads W(0) to 0.98. As time moves on, the filter parameter gradually converges and approaches the value of 0.98, given by the curve 511, using the LMS algorithm. Even as shown in FIG. 5B where there are largely different parameters (i.e., “b=100; W(0)=0.36”) initially, the filter parameter still gradually converges to 0.98 using the LMS algorithm as time moves on. Without adjusting the filter parameter, the value thereof remains the same as the initial one in FIGS. 5A and 5B, such as the line 512. Under different application environments, the convergent value can be different. The adaptive filter can always achieve convergence.

In summary, the invention differs from the prior art in that the invention employs sensors to sense a temperature at a plurality of times and calculates an actual temperature difference between the current time and the previous time. Based on the actual temperature difference, an adaptive filter is used to calculate a predicted temperature difference at a future time. The temperature at the current time and the predicted temperature difference are added to produce a predicted temperature. By calculating the difference between the temperature at the next time and the predicted temperature for the next time, the filter parameter of the adaptive filter is adjusted. Using the above-mentioned means, the invention achieves the goal of increasing the precision of the temperature prediction results.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A temperature prediction system used in a chip having a temperature management mechanism, the system comprising:
a sensing module for sensing a temperature at a plurality of times and continuously calculating a difference between the temperature at the current time and the temperature at the previous time thereof as an actual temperature difference;
a predicting module for using an adaptive filter and a filter parameter thereof to calculate a predicted temperature difference for at least one future time according to the actual temperature difference, and adding the temperature of the current time to the predicted temperature difference for the future time to output a corresponding predicted temperature;
a computing module for calculating a temperature difference between the temperature at the current time and the predicted temperature at the next time thereof as a prediction error; and
an adjusting module for adjusting the filter parameter according to the prediction error.

2. The temperature prediction system of claim 1, wherein the sensing module utilizes a temperature sensor to sense the temperature at all the times and the temperature sensor includes at least a thermistor.

3. The temperature prediction system of claim 1, wherein the filter parameter is e^{-bΔt}^{ₛ}, where b is equal to 1/RC, R is thermal resistance, C is thermal capacitance, and Δtₛ is time increment.

4. The temperature prediction system of claim 1, wherein the adaptive filter uses one algorithm selected from the group consisting of the least mean square (LMS) algorithm or the recursive least square (RLS) algorithm.

5. The temperature prediction system of claim 1, wherein the predicted temperature is calculated using linear extrapolation.

6. A temperature prediction method used in a chip having a temperature management mechanism, the method comprising the steps of:
sensing a temperature at a plurality of times, and continuously calculating a temperature difference between the temperature at the current time and the temperature at the previous time thereof as an actual temperature difference;
using an adaptive filter and a filter parameter thereof to calculate a predicted temperature difference for at least one future time according to the actual temperature difference, and adding the temperature of the current time to the predicted temperature difference for the future time to output a corresponding predicted temperature;
calculating a temperature difference between the temperature at the current time and the predicted temperature at the next time thereof as a prediction error; and
adjusting the filter parameter according to the prediction error.

7. The temperature prediction method of claim 6, wherein the sensing module utilizes a temperature sensor to sense the temperature at all the times and the temperature sensor includes at least a thermistor.

8. The temperature prediction method of claim 6, wherein the filter parameter is e^{-bΔt}^{ₛ}, where b is equal to 1/RC, R is thermal resistance, C is thermal capacitance, and Δtₛ is time increment.

9. The temperature prediction method of claim 6, wherein the adaptive filter uses one algorithm selected from the group consisting of the LMS algorithm or the RLS algorithm.

10. The temperature prediction method of claim 6, wherein the predicted temperature is calculated using linear extrapolation.
